(19) United States
(12) Patent Application Publication
(10) Pub. No.: US 2014/0041774 A1
(43) Pub. Date: Feb. 13, 2014

(54) SOLID TYRE PROVIDED WITH MEANS OF VISUAL INDICATION OF THE STATE OF EXCESSIVE WEAR

(71) Applicants: GIANLUCA ABBATI, TIVOLI (ROME) (IT); GIANLUCA MELORO, TIVOLI (ROME) (IT); DINESH GUNASEKARA, TIVOLI (ROME) (IT); ROBERTO ZAMPIERI, TIVOLI (ROME) (IT)

(72) Inventors: GIANLUCA ABBATI, TIVOLI (ROME) (IT); GIANLUCA MELORO, TIVOLI (ROME) (IT); DINESH GUNASEKARA, TIVOLI (ROME) (IT); ROBERTO ZAMPIERI, TIVOLI (ROME) (IT)

(73) Assignee: TRELLEBORG WHEEL SYSTEMS ITALIA S.P.A., TIVOLI (ROME) (IT)

(21) Appl. No.: 13/931,606

(22) Filed: Jun. 28, 2013

(30) Foreign Application Priority Data
Aug. 13, 2012 (IT) RM2012A 000408

(51) Int. Cl. B60C 7/22

(52) U.S. Cl. CPC B60C 7/22
USPC 152/154.2

(57) ABSTRACT

The present invention concerns a solid tyre (10′) comprising a plurality of circular layers of elastic material overlapping in the radial direction, said layers forming, proceeding from the centre towards the periphery of the tyre, an internal portion or heel (11), an intermediate portion or middle (12) and an external portion or tread (13), wherein, between said intermediate portion or middle (12) and said external portion or tread (13) a layer is interposed of indication of excessive wear (17), having a different colour with respect to that of said tread (13) and made of a material, or a mixture of materials, identical to that of said tread (13), except for the components needed to obtain a different colour.

The present invention relates to a solid tyre provided with means of visual indication of the state of excessive wear.

More specifically, the invention relates to a solid tyre provided with means capable of indicating the state of excessive wear, in particular by means of indications of the visual type.

As is well known, in industrial and commercial applications wheels are often used that, around the rim, are made of solid rubber and plastic compounds, obtained through moulding operations. By way of example, solid tyres are used on many types of industrial vehicles, trucks and trailers. Specifically, one of the most common applications of solid tyres is that of material handling equipment (forklifts).

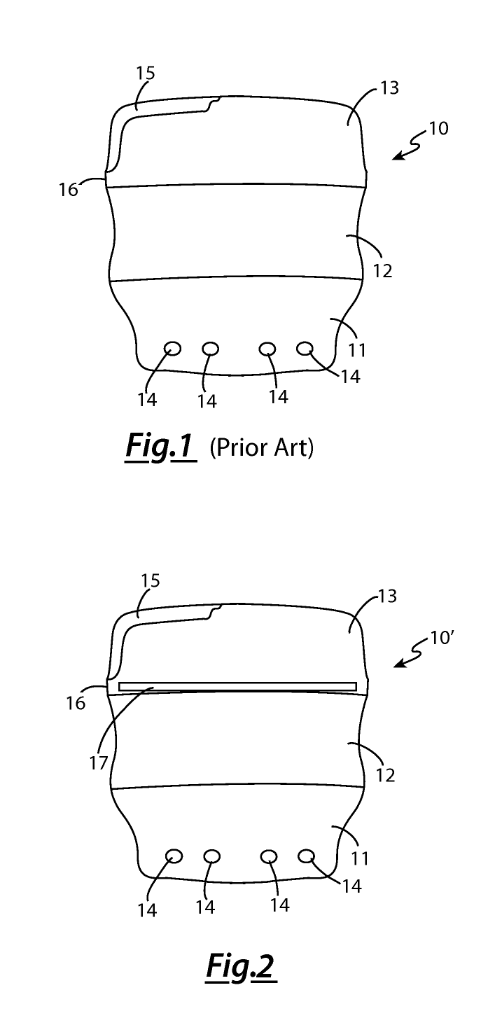

Structurally, referring to FIG. 1, in which a cross-sectional view is shown of the thickness of a solid tyre according to the prior art, this type of tyre, generally indicated with the reference number 10, is comprised of a plurality of circular layers of elastic material overlapping in the radial direction, said layers forming, proceeding from the centre towards the periphery of the tyre, an internal portion called heel 11, an intermediate portion called middle 12 and an external portion called tread 13. In particular, the heel 11 is the portion of the tyre 10 that is mounted around the rim, in turn made integral with the rotation axis which leads the wheel, while the tread 13 is the portion of the structure of the tyre 10 which is in contact with the ground on which the wheel turns, and for these reasons these two different portions of the tyre must be made with particularly resistant materials, while the middle 12 is the portion of the structure which is delegated the function of guaranteeing the elasticity of the tyre 10.

More in particular, in correspondence of the heel 11, the structure of the tyre 10 may be reinforced by a plurality of metal strands 14, while the tread can be smooth or can be provided with grooves 15 whose number, shape and depth vary depending on the use which the tyre 10 is intended for.

Basically, in particular in the case of solid tyres intended for use on machines of industrial type or more generally on machines with reduced movement speed, the function of the grooves of the tread is however of little importance. In fact, the useful life of this type of tyre does not depends on the wear of the grooves of the tread, but rather on the wear of the tread itself in its entirety, the middle devoid of the coverage offered by a sufficient thickness of the tread not being able to guarantee the characteristics suitable for the use of the tyre.

For this reason, again making reference to FIG. 1, the solid tyres 10 are supported by indicators of excessive wear, consisting of a circular portion in relief 16 arranged on the side wall of the tyre, or on the side of the tyre 10, in particular at the side of the area of contact between the tread 13 and the middle 12. These circular portions in relief, which have the function of indicators of the state of excessive wear, are also known with the name of 60J line.

However, users of solid tyres often ask to replace them with new tyres when the wear has reached the bottom of the grooves of the tread. Depending on the type of tyre, or depending on the type of use to which the same is intended, however, the bottom of the grooves of the tread is reached well before reaching the point of excessive wear of the solid tyre. In other words, the bottom of the grooves can be well before reaching the 60J line. In some cases, the thickness of the tread remaining useful to protect the middle and ensure the correct operation of the solid tyre may still be equal to 20-40% of its original thickness.

As a result, users of these tyres are complaining about the fact that the actual useful life is not as declared by the manufacturer.

In light of the above, it appears evident that the solution offered by the indicators of excessive wear according to the known technique, and in particular by the 60J line, does not respond to the need to indicate to a user the actual achievement of the end of useful life of this type of tyres.

In this context it is included the solution according to the present invention, which will provide a solid tyre provided with means of visual indication of the state of excessive wear that will push users to take advantage of the tyre itself to its full potentiality, or up to the effective end of life of the tyre.

These and other results are obtained according to the present invention by proposing a solid tyre provided with means of visual indication of the state of excessive wear which are particularly evident and which effectively report the actual reaching of the end of life of the tyre, but also to sufficiently reassure the user of the not yet reached state of excessive wear.

Purpose of the present invention is therefore to provide a solid tyre provided with means of visual indication of excessive wear that can overcome the limits of the solutions according to the prior art and get the previously described technical results.

Further object of the invention is that said solid tyre can be made with substantially limited costs, both as regards production costs and as regards the costs of management.

Not least object of the invention is to provide a solid tyre equipped with visual indication of the state of excessive wear which is substantially simple, safe and reliable.

It is therefore specific object of the present invention a solid tyre comprising a plurality of circular layers of elastic material overlapping in the radial direction, said layers forming, proceeding from the centre towards the periphery of the tyre, an internal portion or heel, an intermediate portion or middle and an external portion or tread, wherein, between said intermediate portion or middle and said external portion or tread a layer is interposed of indication of excessive wear, having a different colour with respect to that of said tread and made of a material, or a mixture of materials, identical to that of said tread, except for the components needed to obtain a different colour.

Preferably, according to the present invention, said layer of indication of excessive wear is completely surrounded by said middle and said tread.

Moreover, always according to the present invention, said solid tyre additionally comprises a circular portion in relief, arranged on the side wall of the tyre, at the side of the area of contact between the tread and the middle, preferably a circular portion in relief, radially at the same distance from the centre of the tyre than the area of contact between the tread and the middle, and said layer of indication of excessive wear is arranged at a slightly higher distance from the centre of the tyre.

The present invention will now be described, for illustrative but not limitative purposes, according to its preferred embodiment, with particular reference to the figures of the accompanying drawings, in which:

FIG. 1 shows a sectional view of a solid tyre with means of visual indication of the state of excessive wear according to the prior art, and

FIG. 2 shows a sectional view of a solid tyre with means of visual indication of the state of excessive wear according to the present invention.

Referring to FIG. 2, a solid tyre according to the present invention is generally designated by the reference numeral 10′ and is made up of the same parts that constitute the solid tyres according to the prior art (for these parts the same numerical references having been used) and in addition comprises a layer of indication of excessive wear 17, made with a material compatible with that with which the tread 13 and the middle 12 are made of, or with the same material, with the particularity of having a colour clearly distinguishable from the colour of the tread 13, so that, when the wear of the tread 13 is such as to leave uncovered said layer of indication of excessive wear 17, it is immediately and easily visible.

It is clear that the solid tyre according to the present invention constitutes an effective solution to the problem of identifying the correct moment in which an excessive wear is reached, its strong evidence constituting at the same time an effective means of reporting the effective reaching of end of life of the tyre, and also providing a reference whose absence is so obvious as to sufficiently reassure the user of the state of excessive wear of the tyre not yet reached.

The present invention has been described for illustrative but not limitative purposes, according to its preferred embodiments, but it is to be understood that variations and/or modifications can be made by those skilled in the art without departing from the scope of protection as defined by the appended claims.

1. Solid tyre (10′) comprising a plurality of circular layers of elastic material overlapping in the radial direction, said layers forming, proceeding from the centre towards the periphery of the tyre, an internal portion or heel (11), an intermediate portion or middle (12) and an external portion or tread (13), characterised in that, between said intermediate portion or middle (12) and said external portion or tread (13) a layer is interposed of indication of excessive wear (17), having a different colour with respect to that of said tread (13) and made of a material, or a mixture of materials, identical to that of said tread (13), except for the components needed to obtain a different colour.

2. Solid tyre (10′) according to claim 1, characterised in that said layer of indication of excessive wear (17) is completely surrounded by said middle (12) and said tread (13).

3. Solid tyre (10′) according to claim 1, characterised in that it additionally comprises a circular portion in relief (16), arranged on the side wall of the tyre (10′), at the side of the area of contact between the tread (13) and the middle (12).

4. Solid tyre (10′) according to claim 3, characterised in that said circular portion in relief (16) is arranged on the side wall of the tyre (10′), radially at the same distance from the centre of the tyre than the area of contact between the tread (13) and the middle (12), and said layer of indication of excessive wear (17) is arranged at a slightly higher distance from the centre of the tyre.
